(19) United States
(12) Patent Application Publication
(10) Pub. No.: US 2010/0307340 A1
(43) Pub. Date: Dec. 9, 2010

(54) Diffuser Assembly

(76) Inventor: Jesse James, Dieterich, IL (US)

Correspondence Address: WILSON DANIEL SWAYZE, JR., 3804 CLEARWATER CT., PLANO, TX, 75025, US

(21) Appl. No.: 12/481,366

(22) Filed: Jun. 9, 2009

(51) Int. Cl. B01D 53/22

(52) U.S. Cl. 96/6

(57) ABSTRACT

A diffuser assembly for a septic tank may include a top section and a bottom section being heavier than the top section. The top section may be adapted to be connected to a supply of fluid and the top section may include a central member having an aperture being angled downward. The aperture may be angled at an acute angle, and the acute angle may be substantially 35°. The fluid may be air, and the top section may include a plurality of apertures. The central member may be a cylinder, and the top section may include a top member being a cylinder. The top member may be connected to a supply line, and the top section may be detachably connected to the bottom section.

### FIELD OF THE INVENTION

The present invention relates to septic tank systems and more particularly to a diffuser assembly for use in a septic tank.

### BACKGROUND

The most common type of septic system used in the United States consists of a septic tank and some form of secondary treatment system, usually a subsurface seepage system also known as a field absorption system. The septic tanks used in this type of septic system use anaerobic bacteria to break down waste, a process which causes large particles of waste and sludge to remain within the septic tank or secondary treatment system. Such a system is called an anaerobic system. A common problem associated with these types of systems is a build up of biomat. Biomat includes anaerobic bacteria and the waste generated by these anaerobic bacteria processing the organic matter that exits a septic tank. Biomat is located at the bottom and on the side walls of the trenches of the field absorption system and is a part of the cleaning process. The problem with biomat is that after a period of time it grows to the extent that the flow from the septic tank is impeded. Another method by which septic systems break down waste introduces forced air into the septic tank through a diffuser system which causes aerobic bacteria to proliferate in the septic tank and septic system. Such a system is called an aerobic system. In either type of system, anaerobic or aerobic, the processed liquid waste, also called effluent, exits the septic tank through an outlet baffle or a filter assembly and enters into the secondary treatment system where the treatment process continues. An outlet baffle is a mechanism designed to simultaneously enable the discharge of effluent from the septic tank, while limiting the discharge of large particles of waste and sludge from the septic tank. A filter assembly is an outlet baffle that incorporates some type of filter to further restrict the discharge of large particles of waste and sludge. Both outlet baffles and filters exist in a variety of different diameters to meet the particular specifications of various septic systems. A filter can be removed from the filter assembly and cleaned or replaced as needed.

Some aerobic systems employ a clarifier zone or a settling compartment for the purpose of allowing waste particles to settle away from the inlet of the outlet baffle or filter assembly after the waste particles have been broken down by both aerobic action and movement caused by the introduction of air into the septic tank. Single compartment septic tanks that have been converted to use the aerobic process do not have a clarifier zone or settling compartment, and therefore, those moving waste particles can be forced to enter into the inlet of the outlet baffle or the filter assembly by introducing air into the system with an air pump.

A particle recirculator can be added to existing septic tanks and septic systems by attaching the particle recirculator to the existing outlet baffle or filter assembly at two connection points, or by a single vertically elongated connection point. If the existing septic system already has an air pump for aerobic action, then the particle recirculator can utilize this existing air pump to deliver air to the inlet of the outlet baffle or filter assembly.

The particle recirculator can also be incorporated into a new septic system and the outlet baffle or filter assembly that would accompany a new system. Accordingly, the particle recirculator can by manufactured in conjunction with the outlet baffle or filter assembly to create a unified piece. A unified piece can be created by injection molding or other molding techniques. U.S. Pat. No. 7,513,995 is incorporated by reference in its entirety.

### SUMMARY

A diffuser assembly for a septic tank may include a top section and a bottom section being heavier than the top section. The top section may be adapted to be connected to a supply of fluid and the top section may include a central member having an aperture being angled downward.

The aperture may be angled at an acute angle, and the acute angle may be substantially 35°.

The fluid may be air, and the top section may include a plurality of apertures.

The central member may be a cylinder, and the top section may include a top member being a cylinder.

The top member may be connected to a supply line, and the top section may be detachably connected to the bottom section.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a system view of the diffuser assembly of the present invention;

FIG. 2 illustrates a cross-sectional view of the diffuser assembly including separated top section and bottom section;

FIG. 3 illustrates a cross-sectional view of the diffuser assembly including connected top section and bottom section;

FIG. 4 illustrates a bottom view of the diffuser assembly;

FIG. 5 illustrates a perspective view of the diffuser assembly;

FIG. 6 illustrates a top view of the bottom section of the diffuser assembly;

FIG. 7 illustrates a cross-sectional view of the bottom section of the diffuser assembly.

### DETAILED DESCRIPTION

The diffuser assembly 100 may perform multiple tasks. First, the diffuser assembly 100 may self position in an upright position on the bottom of the septic tank. This position may allow a fluid such as air may be introduced at a height inside of the septic tank 102. The diffuser assembly 100 may be relatively heavy on the bottom of the diffuser assembly 100 with respect to the top of the diffuser assembly 100 in order to provide relative buoyancy to the top and should result in the diffuser assembly 100 having the bottom surface in contact with the inside bottom surface of the septic tank 102. This positioning of the diffuser assembly 100 should be achieved even with the septic tank 100 being full of effluent. If the diffuser assembly 100 is initially positioned on its side, touching bottom, the diffuser assembly 100 may tend to right itself as a result of the buoyant top. Even on its side, once the diffuser assembly 100 touches the bottom, the top will want to float up while the base remains firm on the bottom of the tank. This action may result in the diffuser assembly standing upright which may facilitate the operation of the diffuser assembly 100. The diffuser assembly 100 is consequently self positioning into the proper operating position. With a heavy base, the diffuser assembly 100 may not be able to do anything other than stay in the proper upright position. The diffuser assembly 100 additionally converts the process in which wastewater is treated from anaerobic to aerobic bacteria. By eliminating the anaerobic bacteria and processing the wastewater inside the septic tank through the use of aerobic bacteria generated by introducing air into the septic tank through the diffuser assembly, the biomat is isolated from the food source and will break apart and disappear, allowing the failing field or other types of secondary treatment systems to readily absorbed the processed the effluent.

The diffuser assembly 100 may include a tube to define a passageway for fluid such as air to enter the diffuser assembly 100 and to exit the diffuser assembly 100 through small apertures. The tube may be connected to an air supply.

Secondly, anyone who has done any testing on these types of systems would understand that when oxygen is introduced into a septic tank 102, the bubbles of oxygen created will want to rise straight to the top of the septic tank 102. This is similar to holding a large beach ball under the water at your favorite beach or swimming pool and releasing it. The beach ball will shoot quickly to the top of the water and even exit. The same thing happens to the oxygen being introduced into a septic tank 102 by the diffuser assembly 100. Once the oxygen reaches the top of the septic tank 100 the effectiveness of the oxygen is reduced and may no longer promote the growth of aerobic bacteria. Consequently, introducing oxygen high in the septic tank 100 reduces the value of the oxygen to the septic tank 100. Furthermore, the aerobic bacteria may be reduced or nonexistent. The aerobic bacteria will not exist in the bottom of the septic tank 100 under these conditions. The diffuser assembly 100 may introduce oxygen from the fluid such as air close to the bottom of the septic tank 102. Furthermore, the diffuser assembly 100 may include apertures 103 which may be angled downwards towards the bottom of the septic tank 102 at a acute angle with respect to the side of the diffuser assembly 100, and the acute angle of the apertures 103 introduces air (oxygen) approximately near the bottom of a septic tank 102 through multiple apertures angled downward at the acute angle of approximately 35 degrees from top to bottom. When the air passes through these orifices, the created air bubbles want to go straight up, but because of the acute angle, a deflection area 111 is generated around the diffuser assembly 100 which deflects and diffuses the air bubbles and generally prevents the air bubbles from rising directly over the diffuser assembly 100. The air bubbles may be deflected outward 360 degrees around the diffuser assembly 100. This allows the oxygen to stay in the tank much longer than other systems. Secondly the deflector creates a rolling action in the tank. This rolling action provides a mixing function that causes the combined air and water movement to act somewhat like an oversized household blender.

This rolling action which may be created by the deflection of the air bubbles from the diffuser assembly 100 facilitates the breaking down of solid and semisolid particles within the septic tank 102 into smaller particles which is advantageous. Consequently, the aerobic bacteria which maybe generated by the air or oxygen may attach to the smaller particles. The aerobic bacteria can more easily dissolve these smaller particles then the larger solids. The advantages of the diffuser assembly 100 may include as follows:
a) Introduces oxygen close to the bottom of a septic tank
b) Deflects those air bubbles keeping them in the liquid much longer
c) Breaks most waste solids down into small particles usually within a matter of seconds
d) Continually circulates those small particles allowing aerobic bacteria to quickly find and devour them. Naturally, very small particles can be devoured much quicker than large solids

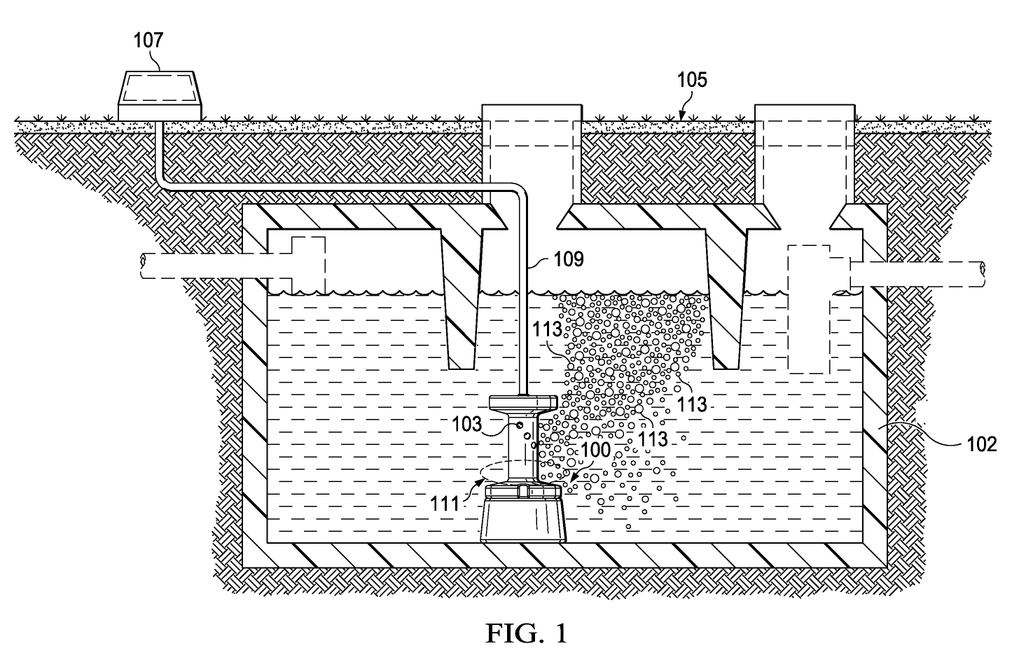

FIG. 1 illustrates a septic tank 102 which may include a diffuser assembly 100 which may be positioned on the bottom of the septic tank 102 which may be located below the ground level 105. A fluid pump which may be a air pump 107 to pump air through a supply line 109 which may be connected to the diffuser assembly 100 of the present invention. FIG. 1 additionally illustrates a deflection area 111 which may extend around the periphery of the diffuser assembly 100 and deflects the air bubbles 113 which are expelled from the aperture 103 of the diffuser assembly 100.

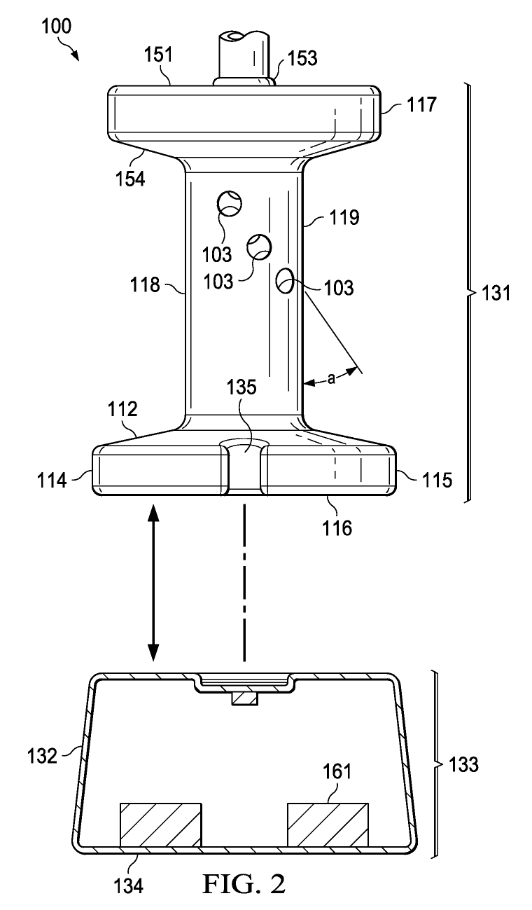

FIG. 2 illustrates an exploded view of the diffuser assembly 100 which may include a top section 131 which may be detachably connected to a bottom section 133. The top section 131 and the bottom section 133 may be formed from substantially rigid material such as metal, plastic or other suitable materials. The top section 133 may include a top cylinder member 117, a narrowed central cylinder member 119 and a bottom cylinder member 115. The top cylinder member 117 may include a top surface 151, a peripheral side surface 152 and a bottom surface 154. The narrowed central cylinder member 119 may include a peripheral side surface 118 which may be connected to the bottom surface 154. The bottom cylindrical member 115 may include a top surface 112, a peripheral side surface 114 and a bottom surface 116. The bottom section 133 may include a peripheral side surface 132 and a bottom surface 134. The top surface 151 of the top cylinder member 117 may include a connection member 153 for connection to a supply line 109 which may be connected to a fluid pump such as an air pump 107 in order to receive a fluid such as air. Additional shapes such as rectangular, trapezoid or the like are within the scope of the invention. The top cylinder member 107 may have a central passageway 155 to communicate with a central chamber 157 of the central cylinder member 119. The central chamber 157 may include multiple apertures 103 which extend from the interior of the central chamber 157 to the exterior of the diffuser assembly 100 at an acute angle ‘a’ which may be substantially 35°. The air enters the top cylinder 117 through the connection member 153 into the central passageway 115 and is transmitted to the central chamber 115 and exits the aperture 103. Small bubbles may be discharged at an angle which may be an acute angle and travel down towards the outside of the diffusion assembly 110 and may be deflected by the deflection area 111 and travels upwards after reaching the deflection area 111. The upward traveling bubbles break apart medium and large solids to create smaller solids which the aerobic bacteria will attach to and dissolve. The central cylinder member 119 may be connected to a bottom cylinder member 115 which may serve as a cover for the bottom section 113. More specifically the bottom cylinder member 115 may cover a weight chamber 159 for storing weights 161 so that the bottom section 113 contacts the bottom surface of the septic tank 102. The bottom surface of the bottom cylindrical member 115 may be detachably connected to the bottom section 113 by a fastening device 135 such as screws or other fastening devices. The number of weights 161 may vary depending on the depth of the septic tank 102 and size of the diffuser assembly 100.

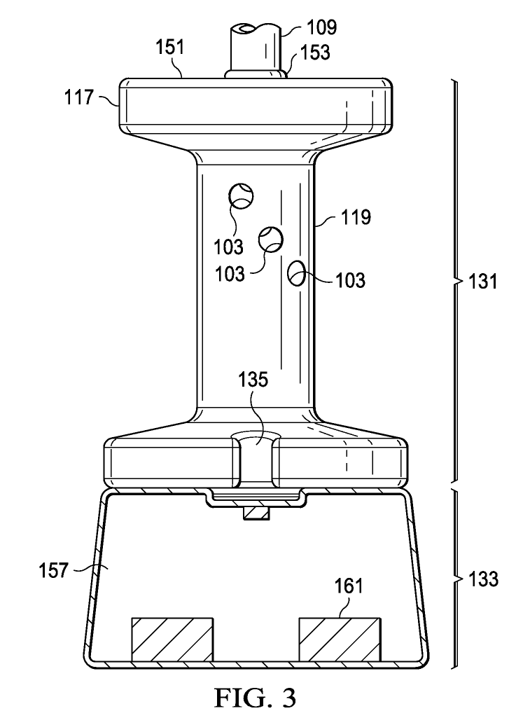

FIG. 3 illustrates a cross-sectional view of the diffuser assembly 100 which may include a top section 131 which may be detachably connected to a bottom section 133. The top section 131 and the bottom section 133 may be formed from substantially rigid material such as metal, plastic or other suitable materials. The top section 133 may include a top cylinder member 117, a narrowed central cylinder member 119 and a bottom cylinder member 115. The top surface 151 of the top cylinder member 117 may include a connection member 153 for connection to a supply line 109 which may be connected to a fluid pump such as an air pump 107 in order to receive a fluid such as air. Additional shapes such as rectangular, trapezoid or the like are within the scope of the invention. The top cylinder member 107 may have a central passageway 155 to communicate with a central chamber 157 of the central cylinder member 119. The central chamber 157 may include multiple apertures 103 which extend from the interior of the central chamber 157 to the exterior of the diffuser assembly 100 at an acute angle ‘a’ which may be substantially 35°. The air enters the top cylinder 117 through the connection member 153 into the central passageway 115 and is transmitted to the central chamber 115 and exits the aperture 103. Small bubbles may be discharged at an angle which may be an acute angle (angled downwards) and travel down towards the outside of the diffusion assembly 110 and may be deflected by the deflection area 111 and travels upwards after reaching the deflection area 111. The upward traveling bubbles break apart medium and large solids to create smaller solids which the aerobic bacteria will attach to and dissolve. The central cylinder member 119 may be connected to a bottom cylinder member 115 which may serve as a cover for the bottom section 113. More specifically the bottom cylinder member 115 may cover a weight chamber 159 for storing weights 161 so that the bottom section 113 contacts the bottom surface of the septic tank 102. The bottom surface of the bottom cylindrical member 115 may be detachably connected to the bottom section 113 by a fastening device 135 such as screws or other fastening devices. The number of weights 161 may vary depending on the depth of the septic tank 102 and size of the diffuser assembly 100. The sidewalls of the diffuser bottom section may be angled inwards to assist the diffuser assembly to stand in the upright position.

FIG. 4 illustrates the bottom surface 134 of the bottom section 133.

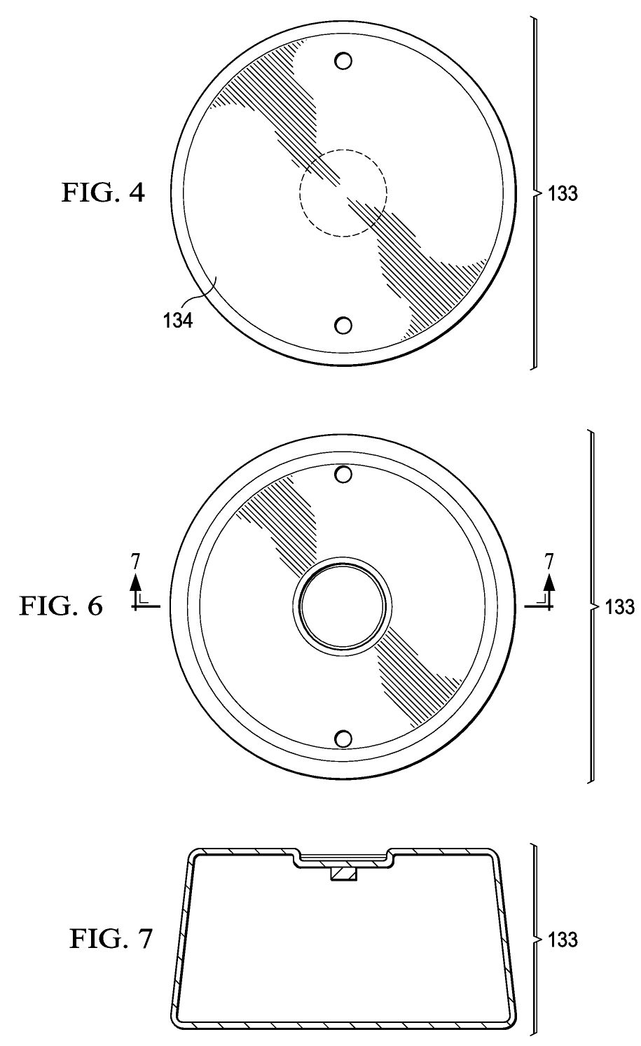

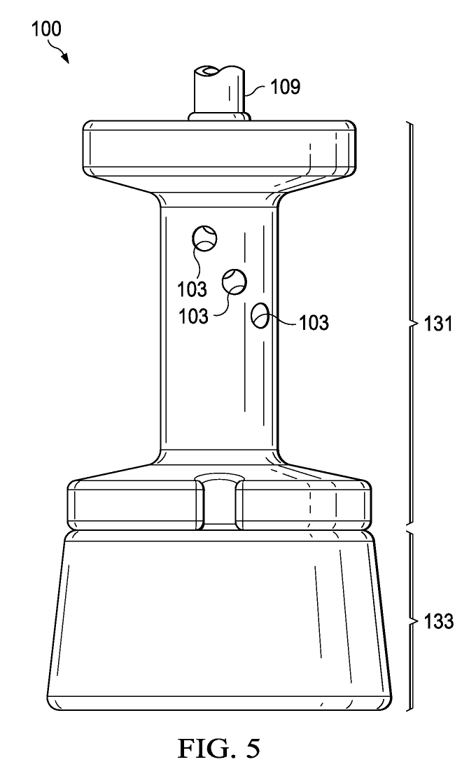

FIG. 5 illustrates a perspective view of the diffuser assembly 100 and illustrates the top section 131 and the bottom section 133. FIG. 5 additionally illustrates the supply line 109.

FIG. 6 illustrates a top view of the bottom section 133 of the diffuser assembly 100, and FIG. 7 illustrates a cross-sectional view of the bottom section 133 of the diffuser assembly 100. FIGS. 6 and 7 illustrates that the top of the bottom section 133 may include a removable lid 661 which may be removed in order to add or remove weights and may be replaced on the top of the bottom section 133.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A diffuser assembly for a septic tank; comprising:
a top section;
a bottom section being heavier than the top section;
wherein the top section is adapted to be connected to a supply of fluid and wherein the top section includes a central member having an aperture being angled downward.

2) A diffuser assembly for a septic tank as in claim 1, wherein the aperture is angled at an acute angle.

3) A diffuser assembly for a septic tank as in claim 2, wherein the acute angle is substantially 35°.

4) A diffuser assembly for a septic tank as in claim 1, wherein the fluid is air.

5) A diffuser assembly for a septic tank as in claim 1, wherein the top section includes a plurality of apertures.

6) A diffuser assembly for a septic tank as in claim 1, wherein the central member is a cylinder

7) A diffuser assembly for a septic tank as in claim 1, wherein the top section includes a top member being a cylinder.

8) A diffuser assembly for a septic tank as in claim 7, wherein the top member is connected to a supply line.

9) A diffuser assembly for a septic tank as in claim 1, wherein the top section is detachably connected to the bottom section.

10) A diffuser assembly for septic tank as in claim 1, wherein the bottom section is adapted to accept different weight quantities to reduce buoyancy of the diffuser.

11) A diffuser assembly for a septic tank as in claim 1, wherein the diffuser includes a deflection area above apertures to deflect the rising air.

12) A diffuser assembly for septic tank as in claim 1, wherein the diffuser assembly includes inwardly extending sidewalls.
